(19) United States
(12) Patent Application Publication
(10) Pub. No.: US 2025/0054322 A1
(43) Pub. Date: Feb. 13, 2025

(54) Attribute Recognition with Image-Conditioned Prefix Language Modeling

(71) Applicant: Google LLC, Mountain View, CA (US)

(72) Inventors: Keren Ye, Mountain View, CA (US); Yicheng Zhu, Mountain View, CA (US); Junjie Ke, San Jose, CA (US); Jiahui Yu, Seattle, WA (US); Leonidas John Guibas, Palo Alto, CA (US); Peyman Milanfar, Menlo Park, CA (US); Feng Yang, Sunnyvale, CA (US)

(21) Appl. No.: 18/787,616

(22) Filed: Jul. 29, 2024

Related U.S. Application Data
(60) Provisional application No. 63/518,407, filed on Aug. 9, 2023.

(51) Int. Cl. G06V 20/70; G06F 40/279

(52) U.S. Cl. CPC G06V 20/70; G06F 40/279

(57) ABSTRACT

Systems and methods for attribute recognition can include obtaining an image and a text string. The text string can be processed with a language model to generate a set of candidate attributes based on sequence based prediction. The image and the candidate attributes can be processed with an image-text model to determine a likelihood that the respective candidate attribute is depicted in the image. The likelihood determination can then be utilized to determine a predicted attribute for the object of interest.

### PRIORITY CLAIM

The present application is based on and claims priority to U.S. Provisional Application No. 63/518,407 having a filing date of Aug. 9, 2023. Applicant claims priority to and the benefit of each of such application and incorporate all such application herein by reference in its entirety.

### FIELD

The present disclosure relates generally to visual attribute recognition. More particularly, the present disclosure relates to the computer vision determination of attributes for an object by leveraging generative prompting.

### BACKGROUND

Artificial intelligence systems can generate accurate and efficient classification of objects when processing an image; however, attribute recognition for the identified objects can be difficult for the computer vision systems. Existing techniques can fail to identify which attributes are associated with the object and what terms are utilized for that object context. For example, orange and black may be an adequate and appropriate description for a dog; however, in cat attribute recognition, the term “calico” may be more precise and accurate.

Additionally, some systems fail to tether the attribute recognition to a particular object in an image, which can lead to the recognized attribute being associated with another object in the image and not the object of interest. For example, an attribute of the sky may be identified when the object of interest is a monument in the foreground.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for attribute captioning. The method can include obtaining, by a computing system including one or more processors, image data and text data. The image data can be descriptive of one or more objects. The text data can be descriptive of a particular object associated with the image data. The method can include processing, by the computing system, the text data with a language model to determine a plurality of candidate attributes. The plurality of candidate attributes can include attributes predicted to be candidate terms that describe attributes of the particular object. The method can include processing, by the computing system, the image data, text data, and candidate attribute with a pre-trained image-text model to determine a probability score for the candidate attribute for each of the plurality of candidate attributes. The probability score can be descriptive of a likelihood the candidate attribute is associated with the image data. The method can include determining, by the computing system, a particular attribute of the plurality of candidate attributes is associated with the particular object depicted in the image data based on the plurality of probability scores.

In some implementations, the methods can include generating, by the computing system, a plurality of prompts based on the text data and the plurality of candidate attributes. The plurality of prompts can be processed with the pre-trained image-text model. The language model may have been trained to predict word sequences. In some implementations, the pre-trained image-text model may have been trained to generate text captions for images. The text captions can be descriptive of features depicted in the image. In some implementations, the plurality of candidate attributes can be determined based on learned word sequences. The learned word sequences may have been learned by training the language model.

In some implementations, the pre-trained image-text model may have been trained on a training dataset including a plurality of training images and a plurality of training captions. Each of the plurality of training captions can be descriptive of a respective caption for one or more of the plurality of training images. The particular attribute can include a particular color. The particular attribute can include a particular texture for the particular object. In some implementations, the particular attribute can include an action description for the particular object. The action description can be descriptive of an action being performed by the particular object in the image data. In some implementations, the particular attribute can include a specialization classification. The specialization classification can be descriptive of an object-specific adjective associated with the particular object.

Another example aspect of the present disclosure is directed to a computing system for language model conditioned image captioning. The system can include one or more processors and one or more non-transitory computer-readable media that collectively store instructions that, when executed by the one or more processors, cause the computing system to perform operations. The operations can include obtaining an image. The image can be descriptive of one or more objects. The operations can include processing the image with a pre-trained image-text model to generate text data. The text data can be descriptive of a particular object depicted in the image. The operations can include processing the text data with a language model to determine a plurality of candidate attributes. The plurality of candidate attributes can include attributes predicted to be candidate terms that describe attributes of the particular object. The operations can include processing, for each of the plurality of candidate attributes, the image, text data, and candidate attribute with the pre-trained image-text model to determine a probability score for the candidate attribute. The probability score can be descriptive of a likelihood the candidate attribute is depicted in the image. The operations can include determining a particular attribute of the plurality of candidate attributes is associated with the particular object depicted in the image based on the plurality of probability scores.

In some implementations, the plurality of candidate attributes can include a plurality of terms determined to be associated with the particular object based on one or more learned sequences. The plurality of candidate attributes can include a plurality of adjectives and a plurality of verbs. The plurality of candidate attributes can include one or more color attributes and one or more texture attributes.

In some implementations, the operations can include processing the text data and the particular attribute with the language model to determine a plurality of additional candidate attributes. The plurality of additional candidate attributes can include attributes predicted to be candidate terms that describe attributes of the particular object with the particular attribute. For each of the plurality of additional candidate attributes, the operations can include processing the image, text data, particular attribute, and candidate attribute with the pre-trained image-text model to determine an additional probability score for the additional candidate attribute. The additional probability score can be descriptive of a likelihood the additional candidate attribute is depicted in the image. The operations can include determining a particular additional attribute of the plurality of additional candidate attributes is associated with the particular object with the particular attribute depicted in the image based on the plurality of additional probability scores.

In some implementations, the operations can include obtaining, before obtaining the image, a training dataset. The training dataset can include a plurality of training examples. In some implementations, each training example can include an image example and a respective caption example. The respective caption example can be descriptive of a caption for the image example. The operations can include training an image-text model based on the training dataset to generate captions for input images.

Another example aspect of the present disclosure is directed to one or more non-transitory computer-readable media that collectively store instructions that, when executed by one or more computing devices, cause the one or more computing devices to perform operations. The operations can include obtaining a training dataset. The training dataset can include a plurality of training examples. Each training example can include an image example and a respective caption example. The respective caption example can be descriptive of a caption for the image example. The operations can include training an image-text model based on the training dataset to generate captions for input images. The operations can include obtaining image data and text data. The image data can be descriptive of one or more objects. The text data can be descriptive of a particular object associated with the image data. The operations can include processing the text data with a language model to determine a plurality of candidate attributes. The plurality of candidate attributes can include attributes predicted to be candidate terms that describe attributes of the particular object. The operations can include processing, for each of the plurality of candidate attributes, the image data, text data, and candidate attribute with the image-text model to determine a probability score for the candidate attribute. The probability score can be descriptive of a likelihood the candidate attribute is associated with the image data. The operations can include determining a particular attribute of the plurality of candidate attributes is associated with the particular object depicted in the image data based on the plurality of probability scores.

In some implementations, the text data can be descriptive of the particular object and a particular adjective for the particular object. The plurality of candidate attributes can be determined based on a text string including the particular object and the particular adjective. The image-text model can include one or more image encoders, one or more unimodal text decoders, and one or more multimodal text decoders.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs attribute recognition according to example embodiments of the present disclosure.

FIG. 1B depicts a block diagram of an example computing device that performs attribute recognition according to example embodiments of the present disclosure.

FIG. 1C depicts a block diagram of an example computing device that performs attribute recognition according to example embodiments of the present disclosure.

FIG. 2 depicts an illustration of an example attribute recognition system according to example embodiments of the present disclosure.

FIG. 3 depicts illustrations of example prompts according to example embodiments of the present disclosure.

FIG. 4 depicts a block diagram of example image-text models according to example embodiments of the present disclosure.

FIG. 5 depicts illustrations of example predictions according to example embodiments of the present disclosure.

FIG. 6 depicts a flow chart diagram of an example method to perform object attribute recognition according to example embodiments of the present disclosure.

FIG. 7 depicts a flow chart diagram of an example method to perform image captioning according to example embodiments of the present disclosure.

FIG. 8 depicts a flow chart diagram of an example method to perform image caption model training and inference according to example embodiments of the present disclosure.

FIG. 9 depicts a block diagram of an example generative prompting attribute recognition according to example embodiments of the present disclosure.

FIG. 10 depicts a flow chart diagram illustrating an example method for training a machine-learned model according to example implementations of aspects of the present disclosure.

FIG. 11 depicts a block diagram of an example processing flow for using machine-learned model(s) to process input(s) to generate output(s) according to example implementations of aspects of the present disclosure.

FIG. 12 depicts a block diagram of an example sequence processing model according to example implementations of aspects of the present disclosure.

FIG. 13 depicts a block diagram of an example technique for populating an example input sequence for processing by a sequence processing model according to example implementations of aspects of the present disclosure.

FIG. 14 depicts a block diagram of an example model development platform according to example implementations of aspects of the present disclosure.

FIG. 15 depicts a block diagram of an example training workflow for training a machine-learned model according to example implementations of aspects of the present disclosure.

FIG. 16 depicts a block diagram of an inference system for operating one or more machine-learned model(s) to perform inference according to example implementations of aspects of the present disclosure.

FIG. 17 depicts a block diagram of an example networked computing system according to example implementations of aspects of the present disclosure.

Reference numerals that are repeated across plural figures are intended to identify the same features in various implementations.

### DETAILED DESCRIPTION

### Overview

Generally, the present disclosure is directed to systems and methods for attribute recognition. In particular, the systems and methods disclosed herein can leverage generative prompting to generate attribute predictions that are object-dependency aware. For example, the systems and methods disclosed herein can utilize a language model and an image-text model to determine attributes based both on learned language sequences and learned image-text relationships. The determined attributes can include characteristics and/or properties associated with one or more objects depicted in the image, which can include details associated with an object color, texture, type, subtype, action, aesthetic, and/or other details associated with the one or more objects. The systems and methods can include obtaining image data and text data in which the image data is descriptive of one or more images and the text data is descriptive of one or more objects in the one or more images. The text data can be processed with a language model to generate a set of candidate attributes. The candidate attributes can be descriptive of attributes determined to be associated with the one or more objects based on learned language sequences. The set of candidate attributes and the image data can then be processed with a pre-trained image-text model to determine a particular attribute that is within the set of candidate attributes and is depicted in the one or more images.

The systems and methods disclosed herein can be utilized for image captioning and/or other computer vision tasks. The determination can include prompt generation and processing that utilizes prompt to perform predictions that are based at least in part on object dependencies. Natural language processing models can be trained and/or configured to predict words and/or phrases that complete a text string and/or come after a given text string. The language models can generate predictions based on learned sequences, which may be leveraged to determine a set of words or phrases that may be associated with a text string associated with an object. Image-text models can be trained and/or configured to output captions based on an input image. The systems and methods disclosed herein can utilize the language model to generate candidate attributes based on learned language relationships and can then utilize the image-text model to evaluate each candidate attribute based on learned image feature and text relationships.

The systems and methods can be utilized for object and/or attribute captioning (e.g., characteristics and/or properties for an object (e.g., large, red, blue, irregular, normal, translucent, bright, furry, coarse, etc.)). For example, the systems and methods can include obtaining image data and text data. The image data can be descriptive of one or more objects (e.g., a cat, a couch, a shirt, a mountain, etc.). The text data can be descriptive of a particular object associated with the image data. In some implementations, the text data can be descriptive of the particular object and a particular adjective for the particular object. The text data may be generated by a classification model, an image-text model, and/or one or more other machine-learned models.

The text data can be processed with a language model to determine a plurality of candidate attributes. The plurality of candidate attributes can include attributes predicted to be candidate terms that describe attributes of the particular object. The candidate terms may be associated with the one or more objects. For example, the candidate terms may include candidate adjectives for the object (e.g., large, bright, colorful, red, green, blue, hairy, small, etc.), candidate actions for the object (e.g., running, walking, standing, winking, moving, staring, posing, etc.), and/or other candidate details descriptive of the scene depicted in the one or more images (e.g., retro, scenic, old, etc.). The candidate attributes may be associated with properties and/or characteristics that may be applicable for the object. The language model may have been trained to predict word sequences. In some implementations, the plurality of candidate attributes can be determined based on learned word sequences. The learned word sequences may have been learned by training the language model. Alternatively and/or additionally, the plurality of candidate attributes can include a plurality of terms determined to be associated with the particular object based on one or more learned sequences. The plurality of candidate attributes can include a plurality of adjectives and a plurality of verbs. In some implementations, the plurality of candidate attributes can include one or more color attributes and one or more texture attributes. The plurality of candidate attributes can be determined based on a text string including the particular object and the particular adjective.

For each of the plurality of candidate attributes, the image data, text data, and candidate attribute can be processed with a pre-trained image-text model to determine a probability score for the candidate attribute. The probability score can be descriptive of a likelihood the candidate attribute is associated with the image data. The pre-trained image-text model may have been trained to generate text captions for images. The text captions can be descriptive of features depicted in the image. In some implementations, the pre-trained image-text model may have been trained on a training dataset including a plurality of training images and a plurality of training captions. Each of the plurality of training captions can be descriptive of a respective caption for one or more of the plurality of training images. The image-text model can include one or more image encoders, one or more unimodal text decoders, and one or more multimodal text decoders.

In some implementations, the systems and methods can include generating a plurality of prompts based on the text data and the plurality of candidate attributes. The plurality of prompts can be processed with the pre-trained image-text model. Prompt generation can be associated with one or more prompt templates. The one or more prompt templates may be machine-learned, user input, and/or a heuristically decided. Prompt generation may include generating a prompt that includes terms associated with the text data and the candidate attribute (e.g., the object name and the candidate attribute name).

The systems and methods can include determining a particular attribute of the plurality of candidate attributes is associated with a particular object depicted in the image data based on the plurality of probability scores. The particular attribute and the text data can be processed to generate a caption that can then be displayed and/or stored. The particular attribute may be a determined characteristic and/or property associated with the particular object. The particular attribute can include a particular color. In some implementations, the particular attribute can include a particular texture for the particular object. Alternatively and/or additionally, the particular attribute can include an action description for the particular object. The action description can be descriptive of an action being performed by the particular object in the image data. The particular attribute can include a specialization classification. The specialization classification can be descriptive of an object-specific adjective associated with the particular object.

In some implementations, the systems and methods can include obtaining a training dataset before obtaining the image. The training dataset can include a plurality of training examples. Each training example can include an image example and a respective caption example. The respective caption example can be descriptive of a caption for the image example. The systems and methods can include training the image-text model based on the training dataset to generate captions for input images.

In some implementations, the process can be performed iteratively as additional details are determined. For example, the object and the determined attribute can be processed to determine additional attributes. The systems and methods can include processing the text data and the particular attribute with the language model to determine a plurality of additional candidate attributes. The plurality of additional candidate attributes can include attributes predicted to be candidate terms that describe attributes of the particular object with the particular attribute. For each of the plurality of additional candidate attributes: the image, text data, particular attribute, and candidate attribute can be processed with the pre-trained image-text model to determine an additional probability score for the additional candidate attribute. The additional probability score can be descriptive of a likelihood the additional candidate attribute is depicted in the image. A particular additional attribute of the plurality of additional candidate attributes can be determined to be associated with a particular object with the particular attribute depicted in the image based on the plurality of additional probability scores.

The systems and methods of the present disclosure provide a number of technical effects and benefits. As one example, the system and methods can be utilized to generate image accurate and language-aware attribute predictions. In particular, the systems and methods disclosed herein can leverage a language model to generate a finite number of candidate attribute predictions based on an initial term (e.g., an object label) and the plurality of candidate attribute predictions can then be evaluated by an image-text model to produce an attribute prediction that is both language sequence aware and image aware.

Another example technical effect and benefit relates to improved computational efficiency and improvements in the functioning of a computing system. For example, a technical benefit of the systems and methods of the present disclosure is the ability to reduce the computational resources needed for training an image-text model. In particular, a pre-trained language model can be utilized to generate a finite number of candidate attribute predictions that can then be evaluated by the image-text model. The process can reduce the training time and resource cost for training an image-text model to generate language accurate results.

With reference now to the Figures, example embodiments of the present disclosure will be discussed in further detail.

### Example Devices and Systems

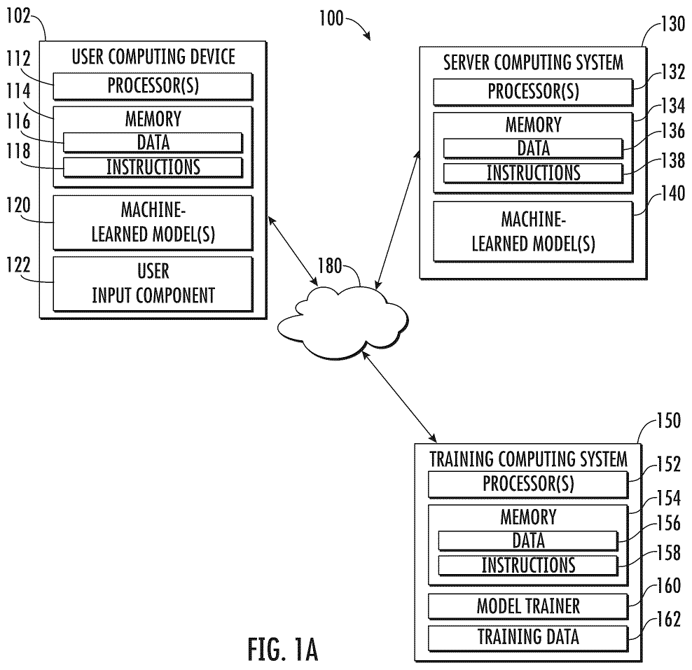

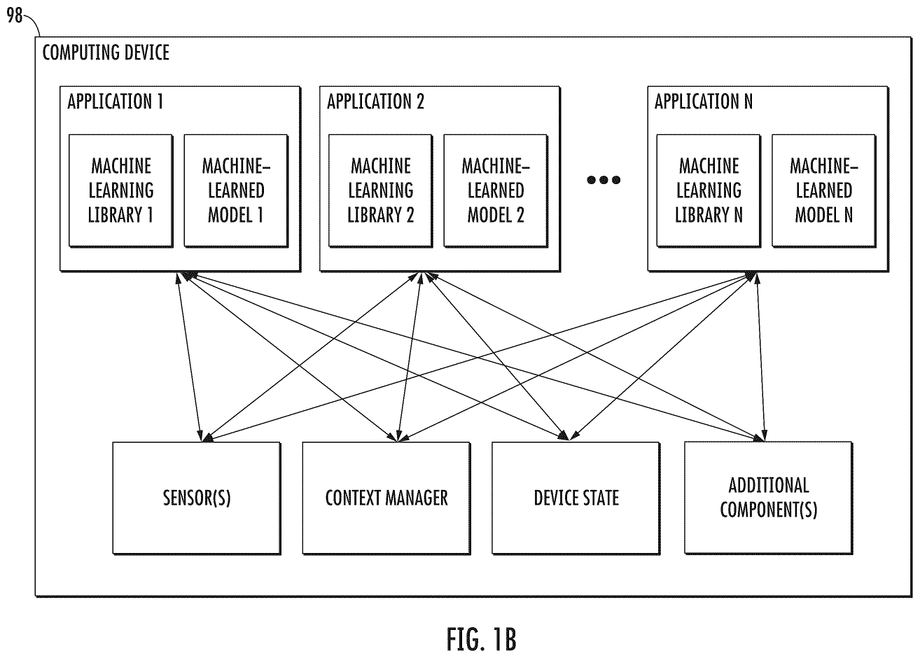

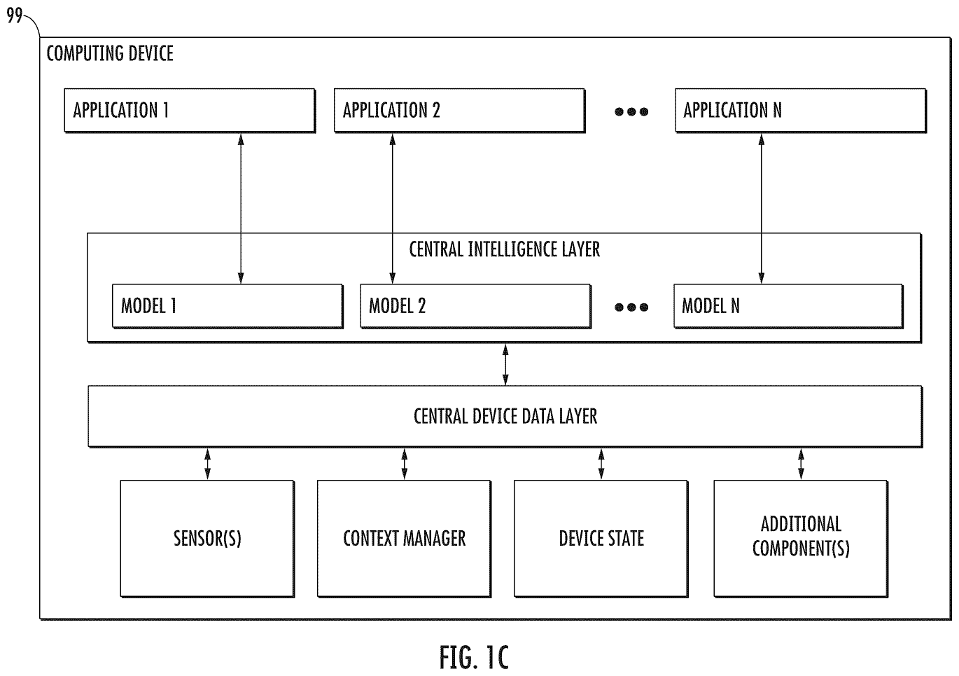

FIG. 1A depicts a block diagram of an example computing system 100 that performs attribute recognition according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

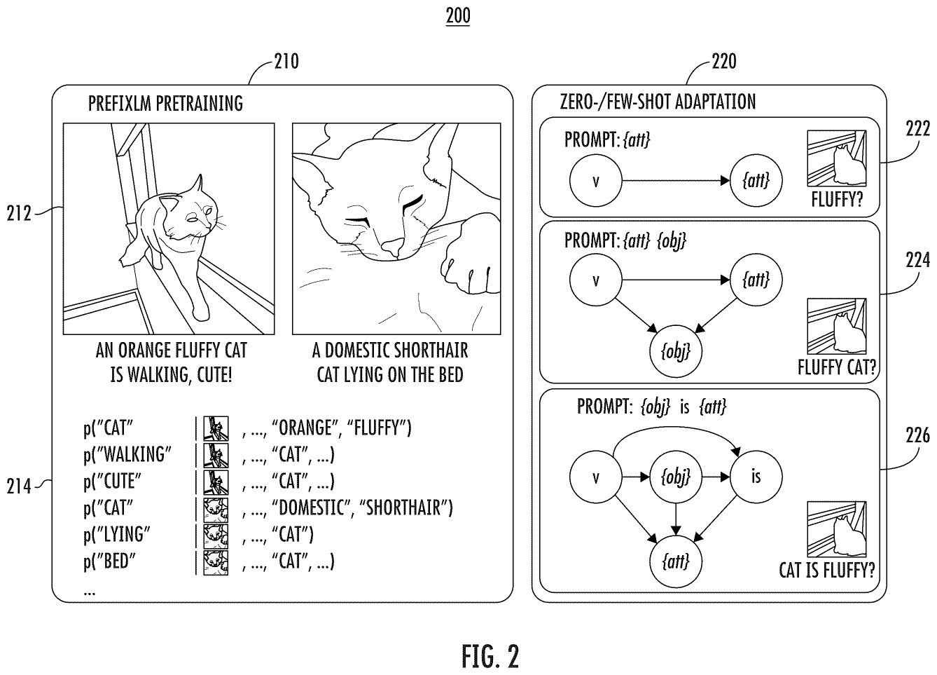

In some implementations, the user computing device 102 can store or include one or more attribute recognition models 120. For example, the attribute recognition models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example attribute recognition models 120 are discussed with reference to FIGS. 2-5.

In some implementations, the one or more attribute recognition models 120 can be received from the server computing system 130 over network 180, stored in the user computing device memory 114, and then used or otherwise implemented by the one or more processors 112. In some implementations, the user computing device 102 can implement multiple parallel instances of a single attribute recognition model 120 (e.g., to perform parallel attribute recognition across multiple instances of objects in image(s)).

More particularly, the attribute recognition model 120 can be trained and/or configured to process image data and text data to generate an attribute prediction associated with an object indicated by the text data. The attribute recognition model can leverage a language model for candidate prediction based on learned word sequences and an image-text model to evaluate the determined candidates.

Additionally or alternatively, one or more attribute recognition models 140 can be included in or otherwise stored and implemented by the server computing system 130 that communicates with the user computing device 102 according to a client-server relationship. For example, the attribute recognition models 140 can be implemented by the server computing system 140 as a portion of a web service (e.g., an image captioning service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned attribute recognition models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the attribute recognition models 120 and/or 140 based on a set of training data 162. The training data 162 can include, for example, image and text caption pairs. The training data 162 can include ground truth data, labeled data, annotated data, image data, text data, embedding data, and/or segmentation data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g., one or more images or videos), the output may include compressed visual data, and the task may be a visual data compression task. In another example, the task may include generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The one or more machine-learned models (120 and/or 140) may include one or more generative models. The one or more generative models may be stored on-device and/or may be stored on a server computing system. In some implementations, the one or more generative models can perform on-device processing to determine suggested searches, suggested actions, and/or suggested prompts. The one or more generative models may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 98 that performs according to example embodiments of the present disclosure. The computing device 98 can be a user computing device or a server computing device.

The computing device 98 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 99 that performs according to example embodiments of the present disclosure. The computing device 99 can be a user computing device or a server computing device.

The computing device 99 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 99.

The central intelligence layer can communicate with a central device data layer. The central device data layer can be a centralized repository of data for the computing device 99. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts an illustration of an example attribute recognition system 200 according to example embodiments of the present disclosure. In some implementations, the attribute recognition system 200 is trained to receive a set of input data 212 descriptive of an image and, as a result of receipt of the input data 212, provide output data that is descriptive of an attribute for an object in the image.

In particular, FIG. 2 can depict prefix language modeling and generative prompting. During pre-training, an image-conditioned prefix language model (prefixLM) 210 can learn to caption images and can curate knowledge regarding object-attribute compositions. In the downstream attribute recognition, a novel generative prompting strategy can be used to rearrange knowledge and to extract reasoning results from prefixLM 210. Different from the contrastive prompting, generative prompting can model the conditional dependence, which can be more representative of factual knowledge.

For example, an image-conditioned prefix language model (prefixLM) 210 can be trained on input data 212 that includes image and caption pairs. The training can include generating a plurality of prompts 214 that can be processed to generate one or more outputs descriptive of a likelihood of an attribute to be associated with an input image.

The training, pretraining, and/or inference can include the zero-/few-shot adaptation 220. In some implementations, one or more example prompts associated with one or more prompt templates may be generated and provided for processing. The prompts may include {att} 222, {att}{obj} 224, {obj} is {att} 226, and/or one or more other configurations. “{att}” can be associated with a candidate attribute, and “{obj}” can be a term, token, and/or embedding associated with a particular object in the input image. Each prompt may be generated with each of the candidate attributes and then processed to determine if the candidate attribute is associated with the image (e.g., does the image depict fluffy, does the image depict a fluffy cat, is the cat in the image fluffy, etc.).

The systems and methods can leverage caption training, prompt generation, and prompt processing to identify attributes with object dependency. The systems and methods can leverage object dependency to (1) identify attributes associated with a particular object in a scene and (2) identify attributes associated with the particular object type for that object.

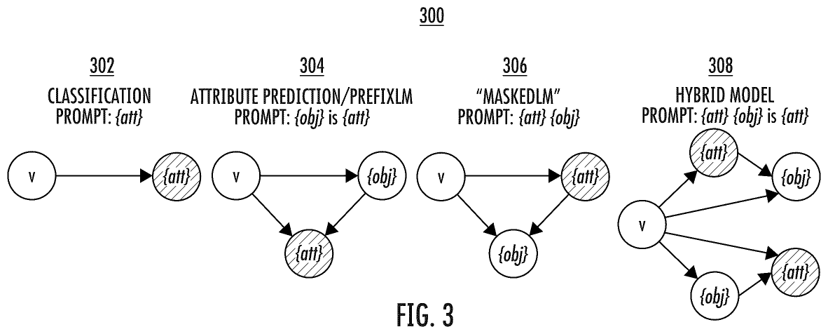

FIG. 3 depicts illustrations of example prompts 300 according to example embodiments of the present disclosure.

In particular, FIG. 3 can depict conditional dependencies that different generative prompts modeled. Attribute recognition can be modeled as a fill-in-the-blank problem for the highlighted “{att}” in the graph. The generative prompting disclosed herein can optimize and/or approximate the joint probability of observing the graph, while the system may rely on the prefixLM pre-training.

For example, the prompts 300 can be configured based on a plurality of prompt templates. Each prompt template can be associated with a different graph that may be utilized to learn relationships and/or perform inferences. A classification prompt template 302 can include {att}, {obj}, or another single dimensional query (e.g., “Does the image have this attribute?”).

An attribute prediction prompt template 304 may provide additional context with regards to what object is being classified and a verb for providing a more detailed prompt. The attribute prediction prompt template 304 may include “{obj} is {att}” (e.g., the shirt is wrinkly). The attribute prediction prompt template 304 can condition the image-text model to perform the determination based on an object-attribute dependency. The attribute prediction prompt template 304 can be utilized for a plurality of attribute types including adjectives, actions, etc.

A MaskedLM prompt template 306 may include “{att}{obj}”. The MaskedLM prompt template 306 can include determining a predicted attribute from an image input isolated from a known object, then determining whether the predicted attribute is associated with the object. The MaskedLM prompt template 306 can perform well for adjective type attributes that may not be object category specific.

A hybrid model prompt template 308 may include “{att}{obj} is {att}”. The hybrid model prompt template 308 can leverage the formats of both the attribute prediction prompt template 304 and the MaskedLM prompt template 306. In some implementations, the hybrid model prompt template 308 may blend the probability prediction of attribute first prediction and object-dependency based prediction.

Each prompt template may generate different probability scores, and different prompt templates may perform more or less accurately for different attribute types and/or for different image/object contexts.

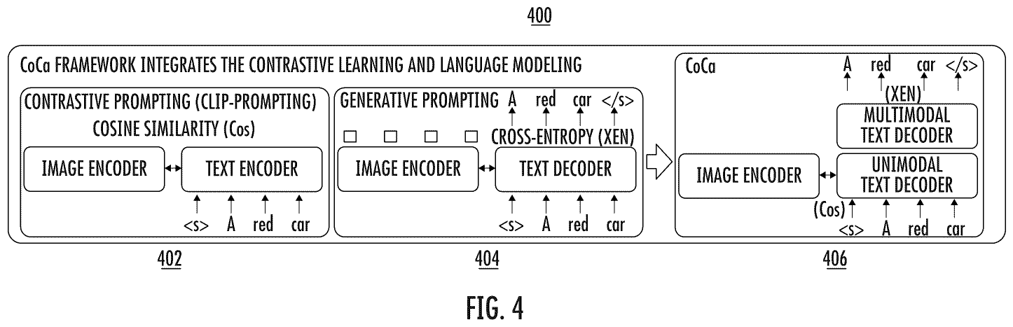

FIG. 4 depicts a block diagram of example image-text models 400 according to example embodiments of the present disclosure. In particular, FIG. 4 can depict an example contrastive prompting model configuration 402, an example generative prompting model configuration 404, and a CoCa model configuration 406 that may be utilized for generative prompting with prefix language modeling. The CoCa model configuration 406 can combine multimodal contrastive learning with image-conditioned prefix language modeling. Each of the model configurations can include one or more encoders and one or more decoders. For example, the models may include an image encoder for generating image embeddings and may include one or more text decoders to output text data based at least in part on the image embeddings. In some implementations, the model configurations may include one or more text encoders to generate text embeddings that may be compared to the image embedding to evaluate the text data.

The CoCa model 406 as depicted in FIG. 4 can integrate both the contrastive learning and prefix language modeling. The text decoder (Unimodal+Multimodal text decoder depicted in the figure) can learn to caption images during training, while the text decoder can share the first few of layers (Unimodal text decoder depicted in the figure) with the text encoder of the contrastive learning.

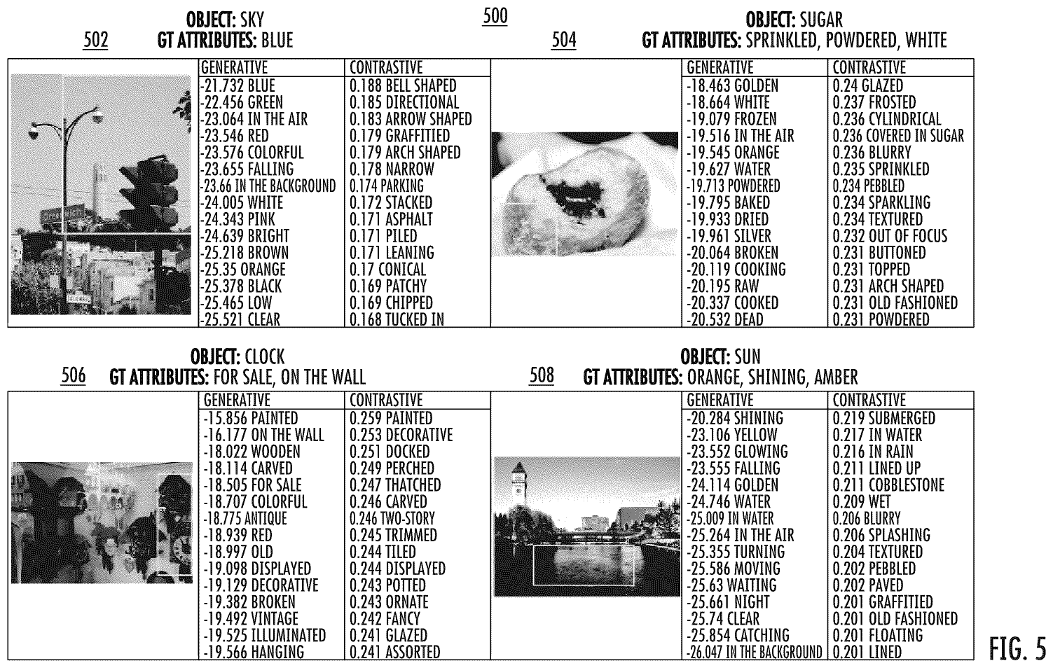

FIG. 5 depicts illustrations of example predictions 500 according to example embodiments of the present disclosure. Each of the example predictions 500 can include one or more terms descriptive of an attribute. Each of the example predictions 500 can be associated with a respective probability score and/or determination.

In particular, FIG. 5 depicts example results from zero-shot attribute prediction. The example results are descriptive of qualitative results on the VAW dataset. Images were cropped using the bounding boxes, such that models only see the areas inside the boxes. For example, the first image 502 may be cropped to focus on a portion of the first image 502 that includes the sky. The cropped portion of the image may be utilized to determine the particular attribute. As depicted in FIG. 5, generative prompting and contrastive prompting can result in very different attribute predictions and probability scores. For 502, the generative prompting predictions include the desired result and a plurality of terms that may be associated with a sky, while the contrastive prompting results are a mixed bag with some results being associated with other objects in the image.

The results for the second image 504 demonstrate a similar divide with the generative prompting results being associated with possible attributes for sugar, while the contrastive prompting results being mixed with some attributes possibly being associated with sugar while other predicted attributes are more associated with the donut as a whole.

The results for the third image 506 and the fourth image 508 also display differing results between generative prompting and contrastive prompting. The results may be descriptive of object-dependency conditioning of the generative prompting system.

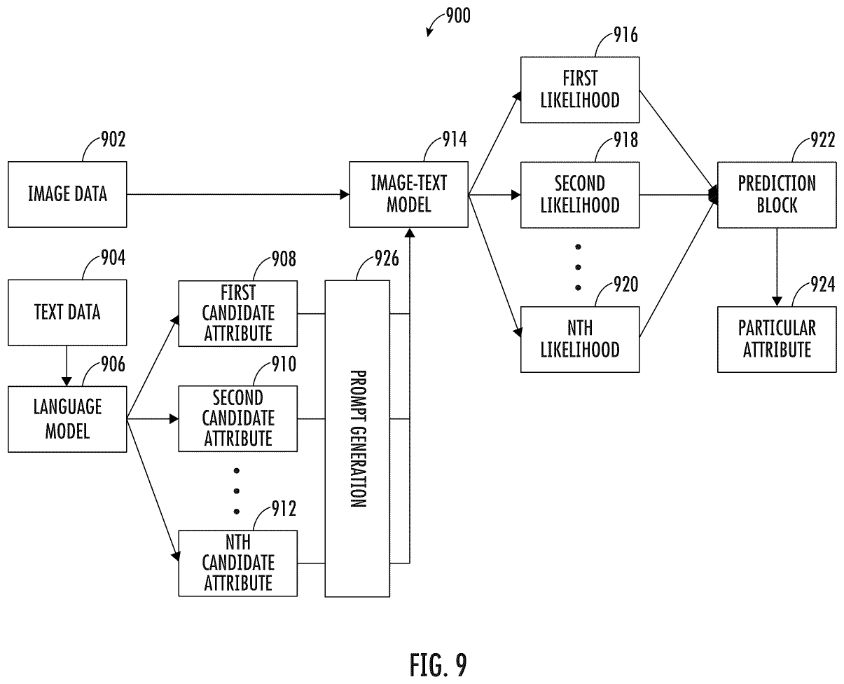

FIG. 9 depicts a block diagram of an example generative prompting attribute recognition 900 according to example embodiments of the present disclosure. In particular, generative prompting attribute recognition 900 can include obtaining and processing image data 902 and text data 904 (and/or object data) to predict one or more attributes for an object depicted in the image data 902.

The image data 902 can depict one or more objects in an environment, and the text data 904 may be descriptive of a particular object depicted in the image data 902. The text data may include an object name and/or one or more object identifiers. The particular object can include a clothing item, an animal, a building, a furniture item, a product, a plant, a monument, a location, and/or a group of features. The text data 904 may be user input, an output of a machine-learned model, and/or a heuristic output.

The text data 904 (and/or the image data 902) may be processed with a language model 906 to generate a plurality of candidate attributes that may be associated with the particular object in the image data 902. The plurality of candidate attributes may be determined based on learned word sequence data and/or learned word relationships. The plurality of candidate attributes can include a first candidate attribute 908, a second candidate attribute 910, and an nth candidate attribute 912. The plurality of candidate attributes can include attributes of the same type and/or may include a diverse array of attributes of different types (e.g., color, texture, action, style, aesthetic, etc.). For example, the first candidate attribute 908 may be associated with a candidate color (e.g., red), the second candidate attribute 910 may be associated with a candidate action (e.g., drifting and/or turning), and the nth candidate attribute 912 may be associated with a candidate aesthetic (e.g., retro and/or 70's).

The language model 906 and/or a separate prompt generation model 926 may then be utilized to generate prompts that include the candidate attributes (e.g., the car is red, the car is drifting, the car is retro, fluffy cat, dreary town, realistic avatar, etc.). One or more prompts can be generated for each candidate attribute. The prompt structure and/or template may be uniform for all candidate attributes. In some implementations, the prompt templates may differ.

The plurality of candidate attributes and/or the plurality of prompts may be processed in parallel (and/or in series) with the image data 902 with an image-text model 914 to generate a plurality of predicted likelihoods. Each of the plurality of predicted likelihoods may be associated with a different candidate attribute and/or a different prompt. For example, a first likelihood 916 may be determined for the first candidate attribute 908, a second likelihood 918 may be determined for the second candidate attribute 910, and an nth likelihood 920 may be determined for the nth candidate attribute 912. The predicted likelihoods may be descriptive of a probability output associated with how likely the image data depicts the particular object with the respective candidate attribute.

The plurality of predicted likelihoods may be processed with a prediction block 922 to determine one or more particular attributes 924 to output for display and/or to store with the image data 902. The one or more particular attributes 924 may be selected based on the candidate attributes with the highest likelihood to be depicted in the image data 902 and be associated with the particular object.

The one or more particular attributes 924 may be provided for display in a user interface as part of an image caption, an image label, an image/object annotation, and/or as a standalone classification. In some implementations, the one or more particular attributes 924 may be stored with the image data 902 for image indexing, image discovery, image grouping, and/or training dataset generation.

### Example Methods

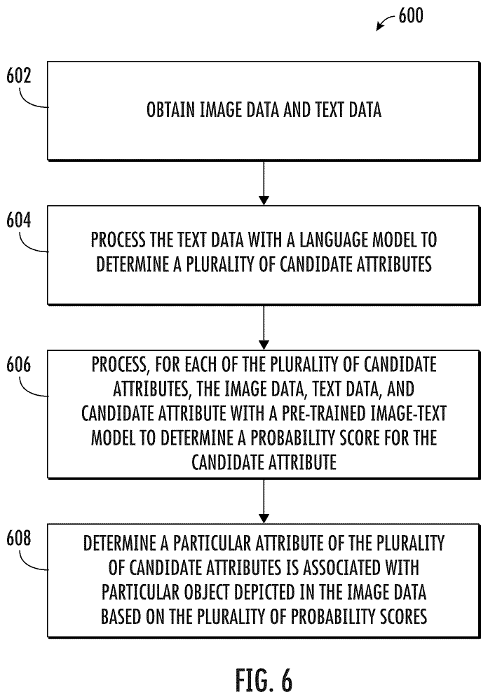

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain image data and text data. The image data can be descriptive of one or more objects. The text data can be descriptive of a particular object associated with the image data. The image data may be obtained from a database (e.g., a local database and/or an online database). Alternatively and/or additionally, the image data may be generated with one or more image sensors and may be processed as a live video feed. The text data may be an initial object label generated with one or more machine-learned models, may be from a user input, and/or may be obtained from image metadata.

At 604, the computing system can process the text data with a language model to determine a plurality of candidate attributes. The plurality of candidate attributes can include attributes predicted to be candidate terms that describe attributes of the particular object. The language model may have been trained to predict word sequences. In some implementations, the plurality of candidate attributes can be determined based on learned word sequences. The learned word sequences may have been learned by training the language model. In some implementations, the language model can include a large language model. The language model may include one or more transformer models. The language model may include one or more natural language processing models that have been trained for word and/or phrase prediction (e.g., next word prediction, and/or fill in the blank prediction).

At 606, the computing system can process, for each of the plurality of candidate attributes, the image data, text data, and candidate attribute with a pre-trained image-text model to determine a probability score for the candidate attribute. The probability score can be descriptive of a likelihood the candidate attribute is associated with the image data. The pre-trained image-text model may have been trained to generate text captions for images. The text captions can be descriptive of features depicted in the image. Additionally and/or alternatively, the pre-trained image-text model may have been trained on a training dataset including a plurality of training images and a plurality of training captions. Each of the plurality of training captions can be descriptive of a respective caption for one or more of the plurality of training images. The likelihood may be descriptive of a probability score of how likely the term is to be the next term in the sequence of words. Alternatively and/or additionally, the likelihood may be descriptive of a probability score that indicates how likely the term is to be the term that fills the mask token.

In some implementations, the computing system can generate a plurality of prompts based on the text data and the plurality of candidate attributes. The plurality of prompts can be processed with the pre-trained image-text model. The prompts may include one or more characters determined based on the text data and one or more tokens associated with where and/or what is being predicted.

At 608, the computing system can determine a particular attribute of the plurality of candidate attributes is associated with a particular object depicted in the image data based on the plurality of probability scores. The particular attribute can include a particular color. In some implementations, the particular attribute can include a particular texture for the particular object. Alternatively and/or additionally, the particular attribute can include an action description for the particular object. The action description can be descriptive of an action being performed by the particular object in the image data. In some implementations, the particular attribute can include a specialization classification. The specialization classification can be descriptive of an object-specific adjective associated with the particular object. The particular attribute may be stored with the image data and text data. In some implementations, the particular attribute and the text data may be processed to generate a caption for the image data. The caption can then be provided for display in a graphical user interface.

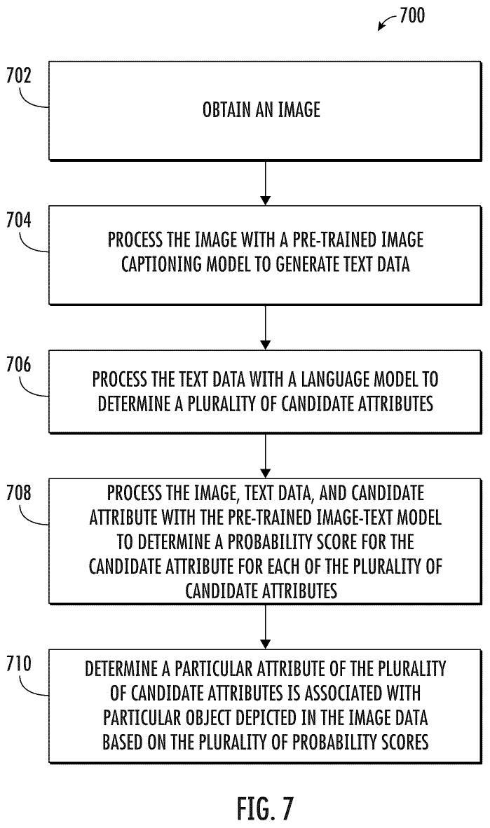

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain an image. The image can be descriptive of one or more objects. The image can include a foreground that includes the one or more objects and a background that includes one or more auxiliary objects and/or an environment. The image may be obtained from local storage on a computing device and/or obtained from a server computing system.

At 704, the computing system can process the image with a pre-trained image-text model to generate text data. The text data can be descriptive of a particular object depicted in the image. The pre-trained image-text model may have been trained to generate captions for input images. In some implementations, the text data may be descriptive of one or more details from the image (e.g., an aesthetic, a texture, a lighting, a location, etc.).

At 706, the computing system can process the text data with a language model to determine a plurality of candidate attributes. The plurality of candidate attributes can include attributes predicted to be candidate terms that describe attributes of the particular object. The plurality of candidate attributes can include a plurality of terms determined to be associated with the particular object based on one or more learned sequences. In some implementations, the plurality of candidate attributes can include a plurality of adjectives and a plurality of verbs. Alternatively and/or additionally, the plurality of candidate attributes can include one or more color attributes and one or more texture attributes.

At 708, the computing system can process the image, text data, and candidate attribute with the pre-trained image-text model to determine a probability score for the candidate attribute for each of the plurality of candidate attributes. The probability score can be descriptive of a likelihood the candidate attribute is depicted in the image. The probability score may be determined based on one or more embedding associations between an embedding of the image and an embedding for the text data plus candidate attribute data. For example, the image may be embedded with an embedding model to generate an image embedding, and the text data and candidate attribute can be processed with an embedding model to generate a text embedding. The image embedding and the text embedding can then be processed to determine the probability score. The image embedding and the text embedding may be associated with a shared image and text embedding space.

At 710, the computing system can determine a particular attribute of the plurality of candidate attributes is associated with a particular object depicted in the image based on the plurality of probability scores. In some implementations, the determination may be performed by a prediction block that processes the plurality of probability scores to determine a candidate attribute with the highest probability score.

In some implementations, the computing system can process the text data and the particular attribute with the language model to determine a plurality of additional candidate attributes. The plurality of additional candidate attributes can include attributes predicted to be candidate terms that describe attributes of the particular object with the particular attribute. For each of the plurality of additional candidate attributes, the computing system can process the image, text data, particular attribute, and candidate attribute with the pre-trained image-text model to determine an additional probability score for the additional candidate attribute. The additional probability score can be descriptive of a likelihood the additional candidate attribute is depicted in the image. The computing system can determine a particular additional attribute of the plurality of additional candidate attributes is associated with the particular object with the particular attribute depicted in the image based on the plurality of additional probability scores.

In some implementations, the computing system can obtain a training dataset before obtaining the image. The training dataset can include a plurality of training examples. Each training example can include an image example and a respective caption example. In some implementations, the respective caption example can be descriptive of a caption for the image example. The computing system can train an image-text model based on the training dataset to generate captions for input images.

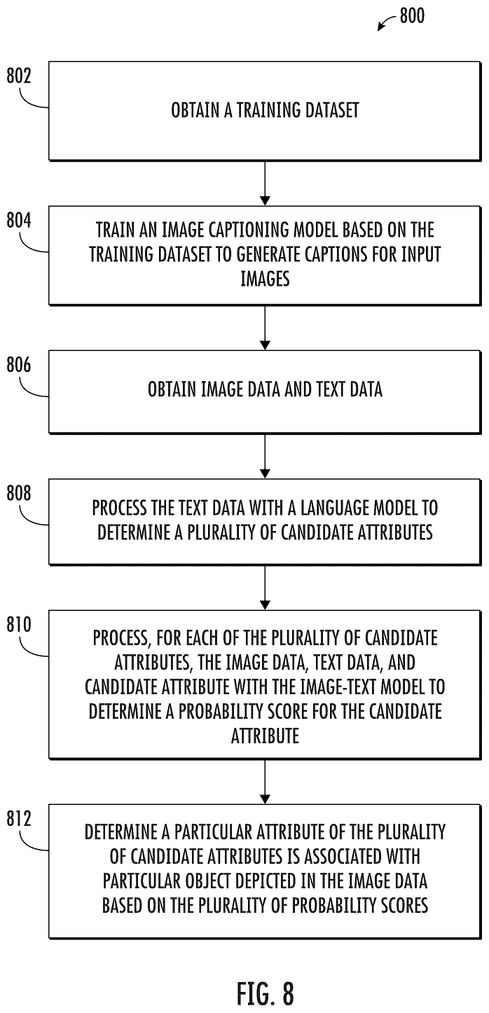

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a training dataset. The training dataset can include a plurality of training examples. Each training example can include an image example and a respective caption example. The respective caption example can be descriptive of a caption for the image example. The training dataset may be obtained from a server computing stem. In some implementations, the training dataset may be obtained by crawling the internet to identify and store image and caption pairs.

At 804, the computing system can train an image-text model based on the training dataset to generate captions for input images. The image-text model can include one or more image encoders, one or more unimodal text decoders, and one or more multimodal text decoders. Training can include ground truth training, an L2 loss, a triplet loss, and/or one or more other training techniques.

At 806, the computing system can obtain image data and text data. The image data can be descriptive of one or more objects. The text data can be descriptive of a particular object associated with the image data. In some implementations, the text data can be descriptive of the particular object and a particular adjective for the particular object.

At 808, the computing system can process the text data with a language model to determine a plurality of candidate attributes. The plurality of candidate attributes can include attributes predicted to be candidate terms that describe attributes of the particular object. In some implementations, the plurality of candidate attributes can be determined based on a text string including the particular object and the particular adjective.

At 810, the computing system can process, for each of the plurality of candidate attributes, the image data, text data, and candidate attribute with the image-text model to determine a probability score for the candidate attribute. The probability score can be descriptive of a likelihood the candidate attribute is associated with the image data.

At 812, the computing system can determine a particular attribute of the plurality of candidate attributes is associated with the particular object depicted in the image data based on the plurality of probability scores. The particular attribute may be provided for display in a user interface. In some implementations, the image may be annotated with the particular attribute.

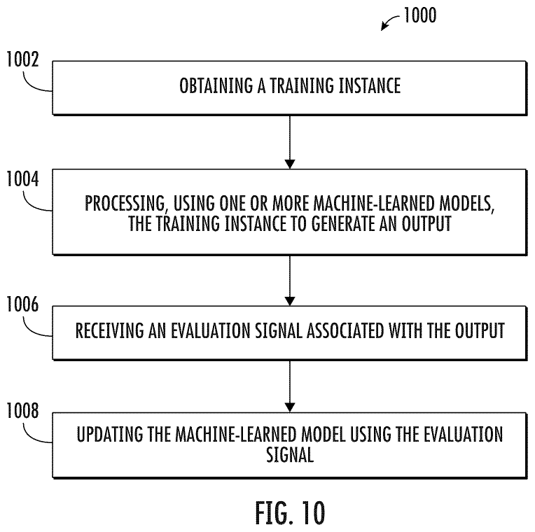

FIG. 10 depicts a flowchart of a method 1000 for training one or more machine-learned models according to aspects of the present disclosure. For instance, an example machine-learned model can include a {reference to claimed model(s)}

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Implementations

Predicting objects and their visual attributes can be fundamental for many artificial intelligence perception applications, which can include visual reasoning, generative AI, and robotics. While zero-shot object recognition can be solved by large language-vision models, visual attribute recognition can remain challenging due to the fact that some previous techniques include contrastively learned representations that do not effectively encode object-attribute dependencies. The systems and methods disclosed herein can address the problem of attribute classification and can utilize generative prompting, which can revolve around a strategy for measuring the probability of generating prompts. Unlike contrastive prompting, generative prompting may be order-sensitive, and the design can reflect the downstream requirements of object-attribute decomposition.

Understanding the attributes associated with objects in an image can provide context for increased accuracy for various computer vision applications, including image retrieval, search, and content recommendation. While supervised learning techniques such as classification, detection, and segmentation models have made significant progress in object recognition tasks, directly adding an object-agnostic attribute prediction branch to these models can be suboptimal as the additional may cause the failure to model the inter-dependency between attributes and objects, resulting in irrelevant or counterfactual outputs. Some existing attribute learning methods may rely heavily on human annotated data to address this dependency, which can make them expensive and hard to scale.

Large-scale image-text foundation models such as CLIP (Radford et al., “Learning transferable visual models from natural language supervision,” in International Conference on Machine Learning, PMLR, 2021, pp. 8748-8763.) and ALIGN (Jia et al., “Scaling up visual and vision-language representation learning with noisy text supervision,” in International Conference on Machine Learning, PMLR, 2021, pp. 4904-4916.) have learned from vast amounts of noisy image-text pairs from the web, effectively utilizing self-supervised learning to benefit from easily accessible data sources. Additionally, the models may show exceptional performance in zero-shot object recognition through image-text similarity measurement, a method which can be referred to as “contrastive prompting”.

In some implementations, applying contrastive prompting to attribute prediction tasks can yield suboptimal performance due to two inherent problems. First, treating the text as an unstructured whole can cause incomplete representations to be learned. As the model is only trained to match image-text pairs, the model may overlook the attributes if the object in the text is distinguishable enough. The overlook can create a discrepancy between the pre-training and the downstream tasks: the model learned to primarily differentiate objects but is later asked to operate on finer attributes.

Another notable limitation of contrastive prompting can be contrastive learning's inability to model the co-dependency of objects and attributes. The inability can be because contrastive pre-training does not capture word sequence order, as opposed to language model pre-training (FIG. 2 (left)). As a result, the model may be unable to filter out counterfactual combinations such as “bell shaped sky” or “parking sky” (see FIG. 5). When contrastive prompting is used to examine these nonsensical object-attribute combinations, the model may still produce confident scores.

The systems and methods disclosed herein can include an approach to address the two aforementioned problems in applying image-text foundation models to attribute learning. In some implementations, the systems and methods can include prefix language modeling (prefixLM) (e.g., (Bengio et al., “A neural probabilistic language model,” Advances in neural information processing systems, vol. 13, 2000.) and (Wang et al., “Simvlm: Simple visual language model pretraining with weak supervision,” arXiv preprint arXiv:2108.10904, 2021.)) as a pre-training foundation and a text generation-based prompting method for extracting structural reasoning information (see FIG. 2). During pre-training, the prefixLM can be trained to predict the next token based on visual inputs and previous texts, which can inherently capture diverse combinations of object-attribute dependencies. In the downstream attribute recognition task, the system can measure the image-attribute alignment by evaluating the probability of generating the attribute prompts, which can be referred to as “generative prompting”. Unlike contrastive prompting, generative prompting can take sequence order into account. Additionally, by adding and rearranging context tokens in the prompt template, the system can model different conditional dependencies, allowing for more flexible models (FIG. 2 (right)) to be applied towards downstream tasks.

The systems and methods may be utilized for a plurality of applications (e.g., two applications for the proposed prefixLM+generative prompting framework can include as a start: (1) describing objects through their visual appearance, state of being, or relationship to other objects in the image and conversely, (2) recognizing objects based on their various visual attributes such as color, shape, size, and so on). Additionally, the systems and methods can be generalized to many other visual tasks that require structural reasoning. The systems and methods can include using prefixLM as a foundational model for capturing complete object-attribute relationships in pre-training and can include a generative prompting mechanism that explicitly models the dependencies between objects and attributes. The generative prompting can serve as a meta-model for attribute recognition to create different probabilistic models. The systems and methods can be evaluated against Visual Genome Attributes (VGA), a benchmark encompassing both attribute and object recognition tasks in a unified setting, to demonstrate the generalizability of the disclosed approach.

The systems and methods can target the attribute learning task. The systems and methods can include generative prompting based on image-conditioned prefix language modeling, which may serve as the foundation for deeper image reasoning tasks. Unlike contrastive prompting, which treats the prompt as a unified feature vector, generative prompting can take sequence ordering into consideration, enabling the modeling of conditional dependencies and the approximation of joint probabilities in graphical models. The systems and methods can have a plurality of potential applications in other visual reasoning problems such as visual relation detection and scene graph generation.

Language modeling (LM) can predict the probability of a sequence of words being observed in a sentence. The large language models (LLMs) may include and/or be based on the transformer architecture. LM can have many applications in both NLP and computer vision, including question answering (QA), conversational question answering (CoQA), visual captioning, and visual question answering (VQA). The applications may be categorized into types of LM (e.g., (1) image-text matching, (2) masked language modeling, and (3) prefix language modeling).

Attribute recognition can be a special type of VQA problem that can include predicting the visual attribute of an object. The foundational methods in the VQA domain can combine image-text matching and masked language modeling. Prefix language modeling (prefixLM) can approximate masked language modeling in the downstream attribute tasks. With a prompting scheme, prefixLM can exhibit even greater expressive power than MLM. The system can generate joint probabilities for specific graphical models, which can enable the modeling of relationships among multiple objects and attributes.

Visual attribute recognition can include identifying the properties of visual objects, such as their color, material or shape. An attribute vector space can be learned and used to recognize unseen visual objects based on the marginal probability. In visual object detection, models may be trained for attribute prediction branches using the visual genome dataset (Krishna et al., “Visual genome: Connecting language and vision using crowdsourced dense image annotations,” International journal of computer vision, vol. 123, pp. 32-73, 2017.) to improve the diversity of the models and create models with multi-task capabilities. The models may concatenate the visual feature with the ground-truth object class embedding and feed this into the attribute prediction branch (img,obj→att). Vector space-based approaches can be utilized in attribute recognition. For example, the model may be applied to attribute learning. The embedding can be used to compare visual information to predefined attribute prompts (img↔obj, att), to determine if the image contains those attributes. The system may allow objects and attributes to be projected into the same feature space, while the decoration of attributes on objects is modeled as an operator (img↔obj OP att, operator OP could be ± or linear transform). The systems and methods disclosed herein can include probability modeling for image, object class, and attribute prediction, while leveraging foundational image-text pre-training models.

The systems and methods can include image-conditioned language modeling. Generative prompting can include image-conditioned prefix language modeling (e.g., image captioning). Given an image v, the system can be tasked with generating the corresponding text x=(s₁, . . . , sₙ) by modeling the probability p(x|v) using Eq. 1. The equation can factor p(x|v) into the product of conditional probabilities, where at each time step, the model predicts the next token sᵢ based on the visual input v and previous tokens (s₀, . . . , sᵢ₋₁) (s₀ is the start-of-sentence token “<s>”).

$$p ( x \vert v ) = {\prod }_{i = 1}^{n} p ( {s}_{i} \vert v , {s}_{1} , … , {s}_{i - 1} ) \qquad ( 1 )$$

The factorization provided by Eq. 1 can be descriptive of a breakdown of the word generation process into individual probability factors. In FIG. 2 (left), the model can capture various object-attribute compositions during pre-training. As a result, in downstream attribute-related tasks, the system can leverage the factorization to address reasoning questions such as p(wₐₜₜ|v,w_{obj}), which represents the probability of observing an attribute wₐₜₜ (e.g., “orange”, “fluffy”) given the visual input v and object w_{obj} (e.g., a “cat”).

Additionally and/or alternatively, the systems and methods can include generative prompting for attribute classification. The system may formalize the prompt-based classification task to establish a common foundation for both generative prompting and contrastive prompting. Specifically, given an image v and text prompts t⁽¹⁾, . . . , t^{(C)} (C is number of classes), prompt-based classification can include designing a loss function L(v,t) to measure the cost of aligning image v and text t⁽ⁱ⁾ (1≤i≤C). Thus, zero-shot classification can be achieved by finding the class label c=argmin_{1≤i≤C}{L(v,t⁽ⁱ⁾)}.

Contrastive prompting can include paired image-text that are projected into the same feature space through contrastive learning during pre-training. Assuming the image is encoded as f(v) and the text is encoded as g(t), the contrastive learning objective can aim to maximize the inner product between the matched image-text embeddings while minimizing the unmatched ones. The task can encourage paired image-text samples to have a high similarity while pushing unpaired samples apart. Under the common assumption of unit norm in the embeddings, the approach can be equivalently represented by using the L2 loss to measure the distance between image and text, denoted as L^{(con)}(v,t)=∥f(v)−g(t)∥₂.

Generative prompting can be utilized for tasks (e.g., attribute recognition). The systems and methods can utilize cross-entropy to evaluate the image-text alignment loss, which is represented as L^{(gen)}(v,t)=−Σᵢ₌₁^{N}\hat{p}(tᵢ)log_{q}_{_{θ}}(v,t_{j|j<i}). Here, \hat{p}(t)∈ [symbol] ^{1×V} (1≤i≤N, N is the length) can represent the one-hot representation of the i-th token of prompt t. To generate the information at the i-th step, the model q_{θ} can be dependent on the image v and all previous text tokens t_{j|j<i} to produce a probability distribution q_{θ}(v,t_{j|j<i})∈ [symbol] ^{V×1} over the vocabulary V. The term −\hat{p}(tᵢ)log_{q}_{_{θ}}(v,t_{j|j<i})∈ [symbol] ¹ can represent the cross-entropy between the i-th token in the prompt t and the model's prediction at the i-th step. FIG. 4 (middle) can provide a visual representation of this equation.

The systems and methods can include modeling the conditional dependence. The generative prompting can be able to model diverse conditional dependencies. Specifically, the prefixLM-based generative prompting can effectively emulate masked language modeling in the downstream attribute recognition tasks. Additionally and/or alternatively, generative prompting can exhibit enhanced expressiveness, enabling the representation of various probability models. FIG. 3 can provide an overview of the different probability graphical models that can be approximated using generative prompting.

Prompt “{att}” can model the simplest dependency for predicting attributes based on the image. In this scenario, the system can focus on the cross-entropy of classifying the image as having a specific attribute, which can be achieved through a simple classification model. The approach aligns with methods that describe attributes rather than naming the objects.

Prompt “{obj} is {att}” can model the prediction of attributes based on both an image and an object p (“{att}”|v, “{obj}”) can be approximated using the prompt “{obj} is {att}”. In this modeling of conditional dependence, all prompts may share the same prefix “{obj} is” (e.g., “cat is orange”, “cat is fluffy”, “cat is cute”, etc.). In some implementations, the only factor that matters in the generative prompting can become −\hat{p}(“{att}”)q_{θ}(v, “{obj}”, “is”), which quantifies the loss associated with classifying an attribute given the image and object.

Prompt “{att} {obj}” can be similar to the MLM (Devlin et al., “BERT: Pre-training of deep bidirectional transformers for language understanding,” in Proceedings of the 2019 Conference of the North American Chapter of the Association for Computational Linguistics: Human Language Technologies, Volume 1 (Long and Short Papers), Minneapolis, Minnesota: Association for Computational Linguistics, June 2019, pp. 4171-4186. DOI: 10.18653/v1/N19-1423. [Online]. Available: https://aclanthology.org/N19-1423.) as it can involve filling in the blank in a sentence like “an image of a [MASK] cat”. However, there can be two key distinctions: (1) p(“{att}”|v) can be reliant on the attribute must be easily recognizable from the image, and (2) p(“{obj}”|v,“{att}”) can be reliant on that the attribute can be employed to modify the object. MLM may use all contextual information to predict the masked token (attribute), regressing to the earlier generative prompt “{obj} is {att}”). The probabilistic modeling of the prompt “{att} {obj}” can utilize attributes for object recognition.

Prompt “{att} {obj} is {att}” can resemble sentences like “fluffy cat is fluffy”. The system can highlight the prompt to showcase the versatility of generative prompting. The prompt can encompass all three previously discussed conditional probability terms: (1) p(“{att}”|v)−classification; (2) p(“{obj}”|v,“{att}”)—object-attribute compatibility; and (3) p(“{att}”|v,“{obj}”)—attribute prediction based on image and object. The systems and methods can present an approximate probability graph representation (e.g., in FIG. 3 (right)), where the system can duplicate both the attribute and object nodes. With the duplicated “{att}” in the prompt, the resulting modeling can account for the inter-dependency between object and attribute. For example, attributes preceding objects: “red car”, “blue sky”; and objects preceding attributes: “kid is smiling” and “cat is lying”.

The generative prompting can differ from other methods in a variety of ways. Firstly, from the language modeling perspective, the systems and methods can offer a solution for training using prefixLM, enabling the mimicking of MLM or more advanced LM in a zero-shot manner for downstream tasks. Secondly, the generative prompting can serve as a meta-model for attribute recognition, as the system can modify the probabilistic modeling and conditional dependence through changes in text prompts.

In some implementations, the systems and methods can include finetuning on attribute tasks. Since the attribute class names can have similar lengths, the cross-entropy scores L^{(gen)}(v,t) with the image can be expected to fall within a similar range of values (see FIG. 5). One way to adapt the knowledge in a few-shot manner can be to learn to “rescale” the prompting scores to adapt to the new dataset priors during finetuning. Specifically, if t^{(c)} is the prompt for class c, the system can introduce learnable parameters bias μ_{c} and scaling factor σ_{c} to adjust the L^{(gen)}(v,t^{(c)}), resulting in a transformed probability

$${p}_{c} = sigmoid ( - \frac{{L}^{( gen )} ( v , {t}^{( c )} ) - {μ}_{c}}{{σ}_{c}} ) .$$

The probability p_{c} can represent the likelihood of the image-object pair being associated with attribute c. During finetuning, p_{c} can be optimized using cross-entropy loss.

Language modeling with large language models can have increased computational cost. Generative retrieval can have n autoregressive text decoding steps, where n is the length of the retrieval template sentence, while contrastive retrieval may have one text encoding step. Given the short and fixed-length sentence templates in the attribute learning context, the computational complexity of generative retrieval may be n× contrastive (n=2 to 4). In addition, the text-only attribute embeddings in contrastive retrieval can be precomputed and cached in advance, which can make contrastive retrieval take encoding steps at inference time. This may not be possible for generative retrieval, as it may not be possible to precompute a part of the likelihood of generating an image-object-attribute triple. Another limitation to generative retrieval approaches may be that generative retrieval approaches can be specifically designed for tasks where the assumed lengths of answers or prompts are similar. Since the sum of log probabilities in L^{(gen)} may be influenced by the length of the text, the approach may be biased towards shorter answers. In the context of attribute prediction tasks, the assumption of similar lengths may hold true, allowing the system to treat attribute prompt optimization as joint probability optimization in a graph model. This task formulation may set it apart from VQA tasks, which may typically involve multiple-choice questions with answers of varying lengths.

### Example Experiments

In some implementations, the systems and methods can leverage the CoCa Model (Yu et al., “Coca: Contrastive captioners are image-text foundation models,” arXiv preprint arXiv:2205.01917, 2022.) as the prefixLM foundation model. CoCa can combine multimodal contrastive learning with image-conditioned prefix language modeling, as illustrated in FIG. 4. The text decoder of the model can include (1) a unimodal text decoder trained on the contrastive learning task with the image encoder, and (2) a multimodal text decoder that generates captions by cross-attending to the image encoder. The system may leverage CoCa since the CoCa model can enable both contrastive and generative prompting in a single model. The CoCa model configuration can ensure a fair comparison between the two prompting approaches as they are trained on the same image-text data.

In the experiments, the evaluation can employ the “base” version of CoCa, which can include a ViT (Kolesnikov et al., “An image is worth 16×16 words: Transformers for image recognition at scale,” in International Conference on Learning Representations (ICLR), 2021.) image encoder with 12 transformer layers, a unimodal text decoder with 6 layers, and a multimodal text decoder with an additional 6 layers. The image resolution can be set to 224×224 pixels with a patch size of 16×16 pixels. The transformer layers may have hidden dimensions of 768 and MLP size of 3,072.

The CoCa model can be pre-trained on a 650 M subset from the English split in LAION-5B dataset (Schuhmann et al., “Laion-5b: An open large-scale dataset for training next generation image-text models,” in Advances in Neural Information Processing Systems (NeurIPS), 2022.). The filtered subset can be obtained by removing non-informative or low-quality data, such as bad image size or poorly formatted text. The study can be directed at evaluating attribute recognition performance on two attribute datasets: visual attribute in the wild and visual genome attributes.

Visual Attribute in the Wild (VAW) (Pham, K. Kafle, Z. Lin, Z. Ding, S. Cohen, Q. Tran, and A. Shrivastava, “Learning to predict visual attributes in the wild,” in Proceedings of the IEEE/CVF Conference on Computer Vision and Pattern Recognition (CVPR), 2021, pp. 13 018-13 028.) can be a large-scale dataset of images with explicitly labeled positive and negative attributes. The VAW attribute recognition task can be dependent on models to predict visual attributes given an image-object pair. VAW can include 216,790 instances from 58,565 images for training, 12,286 instances from 3,317 images for validation, and 31,819 instances from 10,392 images for testing. The experiments can use the test set to measure zero-shot attribute prediction.

Visual Genome Attributes (VGA) can include a modified version of the Visual Genome (VG) dataset (Krishna et al., “Visual genome: Connecting language and vision using crowdsourced dense image annotations,” International journal of computer vision, vol. 123, pp. 32-73, 2017.) designed to evaluate the attribute learning performance. VG can be a comprehensive image dataset with extensive annotations, including region descriptions, attributes, and relationships. In the study, the experiments can utilize the attribute annotations from VG and construct two variants of the dataset: one for predicting attributes given objects (Visual Genome Attributes-attribute ranking or VGA-A) and another for predicting objects given attributes (Visual Genome Attributes-object ranking or VGA-O). Both tasks may be defined as ranking tasks, where the objective is to rank ground truth pairs higher than false pairs. For VGA-A, the ground truth can be the paired object-attribute, while false pairing attributes are selected as those that are often associated with the object but are not present in the current image. For example, for “car is red”, false pairing attributes may be “car is blue” and “car is yellow”. For VGA-O, negatives can be those with incorrect objects. For example, given “car is red”, negatives can be “bird is red” and “logo is red”. As a result, the system can obtain a dataset with 770,721 training images, 7,997 validation images, and 32,299 testing images, for both tasks.

The results on the VAW dataset can demonstrate the superiority of generative prompting over contrastive prompting, followed by an exploration of various conditional dependence models.

The VAW dataset and the following metrics were used: rank (average rank of the correct predictions out of all 620 choices), mR@15 (mean recall over all classes at top 15 predictions for each instance), and mAP (mean average precision over all classes). Rank can be a more comprehensive metric than mR@15 and mAP, as ranking can better capture the ranking quality of correct predictions in a large candidate space.

Table 1 can display zero-shot results on the VAW dataset.

| | Prompt Templates | Rank↓ | mR@15↑ | mAP↑ |
|---|---|---|---|---|
| Cont. | “{att}” | 95.1 | 32 | 52.5 |
| | “{att}{obj}” | 149.8 | 22.4 | 47.1 |
| | “{obj} is {att}” | 151.4 | 23.2 | 45.9 |
| | “{att}{obj} is {att}” | 141 | 23.7 | 48.3 |
| Gene. | “{att}” | 82.1 | 28.7 | 53.8 |
| | “{att}{obj}” | 63.9 | 35.9 | 47.7 |
| | “{obj} is {att}” | 61.9 | 32.9 | 46.1 |
| | “{att}{obj} is {att}” | 56 | 31.7 | 49.9 |

Table 2 can display finetuning results on the VAW dataset.

| | Prompt Templates | Rank↓ | mR@15↑ | mAP↑ |
|---|---|---|---|---|
| Cont. | “{att}” | 18.3 | 48.6 | 69.6 |
| | “{att}{obj}” | 12.8 | 59.8 | 65.7 |
| | “{obj} is {att}” | 12.3 | 58.9 | 66.7 |
| | “{att}{obj} is {att}” | 12.2 | 59.6 | 67.3 |
| Gene. | “{att}” | 18 | 50.5 | 71.7 |
| | “{att}{obj}” | 11.4 | 61.8 | 70.8 |
| | “{obj} is {att}” | 11.1 | 62.1 | 72 |
| | “{att}{obj} is {att}” | 10.6 | 62.6 | 71.9 |

Table 1 and 2 can convey the results of the zero-shot and fine-tuning settings, respectively. In both scenarios, generative prompting can outperform contrastive prompting in both settings, demonstrating a stronger ability to model fine-grained associations between objects and attributes. Under the best-performing prompt template, the generative prompting can achieve a rank of 56.0 compared to 95.1 (↑ lower is better) for contrastive prompting in the zero-shot setting (Table 1). Similarly, in the finetuning setting (Table 2), the comparison is 10.6 versus 12.2. There can be two underlying reasons for generative prompting's results. Firstly, generative prompting can capture true attributes, while contrastive prompting may learn superficial connections through objects (as shown in Table 1, adding object hints in contrastive prompting makes it perform worse). Secondly, generative prompting may better model the object-attribute relationship, taking into account their dependencies and interactions, while contrastive prompting may be unable to eliminate counterfactual attribute-object pairs.

FIG. 4 can display some qualitative examples that illustrate the differences between generative prompting and contrastive prompting. In the top-left example, the contrastive prompting ranks the attributes “sky is bell shaped” and “sky is graffitied” highly, even though these attributes do not apply to the sky. Instead, they are highly associated with objects present in the image or are implied. This can show that contrastive prompting can surface attributes based on the associations learned in contrastive learning pre-training, which may be undesirable for accurate attribute recognition.

In Table 1 and 2, the experimental results can be displayed for the four types of graphical models (see FIG. 3) that generative prompting approximate. The experimental result display uses the zero-shot results in Table 1 (bottom) to describe findings, as the finetuning shows similar trends.

Prompt “{att}” may achieve a rank of 82.1 among the four probabilistic models. This can be because the system failed to model the important object prior.

Prompt “{att} {obj}” can perform significantly better (63.9 rank) than the previous approach in that object hint is considered. The generative prompt first classifies attributes, then checks whether the attributes fit the “[MASK] {obj}”. Different from MLM in this context, p(“{obj}”|“{att}”) can be modeled in the fill-in-the-blank rather than p(“{att}”|“{obj}”).

Prompt “{obj} is {att}” can produce similar results (61.9 rank) to “{att} {obj}”. The baselines on the VAW in Table 3 can be analogous to this formulation yet the model may not be the best among the four graphical models. Therefore, improving the probability modeling may potentially improve these SOTA methods, and the generative prompting may offer a solution.

Prompt “{att} {obj} is {att}” can perform with an average rank of 56.0. The underlying reason for the success may be that the model prompting considers three important factors: p(“{att}”|v), p(“{obj}”|v, “{att}”), and p(“{att}”|v, “{obj}”), all easily captured by the proposed generative prompting.

The experiments can be utilized to compare the fine-tuned model to the state-of-the-art methods using the following metrics from (Pham et al., “Learning to predict visual attributes in the wild,” in Proceedings of the IEEE/CVF Conference on Computer Vision and Pattern Recognition (CVPR), 2021, pp. 13 018-13 028.): mAP (mean average precision over all classes), mR@15 (mean recall over all classes at top 15 predictions in each instance), mA (mean balanced accuracy over all classes), and F1@15 (overall F1 at top 15 predictions). The following baselines were considered: ResNet-Bas.-CE ((Anderson et al., “Bottom-up and top-down attention for image captioning and visual question answering,” in Proceedings of the IEEE Conference on Computer Vision and Pattern Recognition (CVPR), 2018.) and (Jiang et al., “In defense of grid features for visual question answering,” in IEEE/CVF Conference on Computer Vision and Pattern Recognition (CVPR), 2020.)) and ResNet-Bas. (Patterson et al., “Coco attributes: Attributes for people, animals, and objects,” in Computer Vision-ECCV 2016: 14th European Conference, Amsterdam, The Netherlands, Oct. 11-14, 2016, Proceedings, Part VI 14, Springer, 2016, pp. 85-100.) added attribute heads to the ResNet (He et al., “Deep residual learning for image recognition,” in Proceedings of the IEEE Conference on Computer Vision and Pattern Recognition (CVPR), 2016.). LSEP (Li et al., “Improving pairwise ranking for multi-label image classification,” in Proceedings of the IEEE Conference on Computer Vision and Pattern Recognition (CVPR), 2017.) applied ranking loss. Sarafianos et al. (Sarafianos et al., “Deep imbalanced attribute classification using visual attention aggregation,” in Proceedings of the European Conference on Computer Vision (ECCV), 2018, pp. 680-697.) integrated multi-attention. PartialBCE+GNN (Durand et al., “Learning a deep convent for multi-label classification with partial labels,” in Proceedings of the IEEE/CVF Conference on Computer Vision and Pattern Recognition (CVPR), 2019.) and ML-GCN (Chen et al., “Multi-label image recognition with graph convolutional networks,” in Proceedings of the IEEE/CVF Conference on Computer Vision and Pattern Recognition (CVPR), 2019.) considered label-correlation by building graph neural network. Finally, the strongest baseline SCONE (Pham et al., “Learning to predict visual attributes in the wild,” in Proceedings of the IEEE/CVF Conference on Computer Vision and Pattern Recognition (CVPR), 2021, pp. 13 018-13 028.) and TAP (Pham et al., “Improving closed and open-vocabulary attribute prediction using transformers,” in Proceedings of the European Conference on Computer Vision (ECCV), 2022.) combined contrastive learning, multi-hop attention, reweighting techniques.

Table 3 can include results from comparing to the SOTA on the VAW dataset. The top rows can show the baseline models from multi-label learning or attribute prediction works; the last three rows can show the results of the method which finetunes the generative prompts. For mA, mA@threshold=0.005 can be reported as cross-validated.

(a)

| | Overall | | | | Class imb. mAP | | |
|---|---|---|---|---|---|---|---|
| Methods | mAP | mR@15 | mA | F1@15 | Head | Med. | Tail |
| ResNet-Bas.-CE | 56.4 | 55.8 | 50.3 | 61.5 | 64.6 | 52.7 | 35.9 |
| LSEP | 61 | 50.7 | 67.1 | 62.3 | 69.1 | 57.3 | 40.9 |
| PartialBCE + GNN | 62.3 | 52.3 | 68.9 | 63.9 | 70.1 | 58.7 | 40.1 |
| ResNet-Bas.-CE | 63 | 52.1 | 68.6 | 63.9 | 71.1 | 59.4 | 43 |
| ML-GCN | 63 | 52.8 | 69.5 | 64.1 | 70.8 | 59.8 | 42.7 |
| Sarafianos et al. | 64.6 | 51.1 | 68.3 | 64.6 | 72.5 | 61.5 | 42.9 |
| SCoNE | 68.3 | 58.3 | 71.5 | 70.3 | 76.5 | 64.8 | 48 |
| TAP | 73.4 | 63.3 | 73.5 | 71.1 | — | — | — |
| “{att}{obj}” | 70.8 | 61.8 | 73.7 | 68.3 | 74 | 71 | 58.2 |
| “{obj} is {att}” | 72 | 62.1 | 74.7 | 68.7 | 74.9 | 72 | 60.6 |
| “{att}{obj} is {att}” | 71.9 | 62.6 | 74.4 | 68.7 | 75 | 72.1 | 59.4 |

(b)

| | Attribute types mAP | | | | | | |
|---|---|---|---|---|---|---|---|
| Methods | Colo. | Mate. | Shap. | Size | Text. | Acti. | Other |
| ResNet-Bas.-CE | 54 | 64.6 | 55.9 | 56.9 | 54.6 | 47.5 | 59.2 |
| LSEP | 56.1 | 67.1 | 63.1 | 61.4 | 58.7 | 50.7 | 64.9 |
| PartialBCE + GNN | 57.7 | 66.5 | 64.1 | 65.1 | 59.3 | 54.4 | 65.9 |
| ResNet-Bas.-CE | 58.5 | 66.3 | 65 | 64.5 | 63.1 | 53.1 | 66.7 |
| ML-GCN | 59.1 | 64.7 | 65.2 | 64.2 | 62.8 | 54.7 | 66.5 |
| Sarafianos et al. | 62.9 | 68.8 | 64.9 | 65.7 | 62.3 | 56.6 | 67.4 |
| SCoNE | 70.4 | 75.6 | 68.3 | 69.4 | 68.4 | 60.7 | 69.5 |
| TAP | — | — | — | — | — | — | — |
| “{att}{obj}” | 73.1 | 75 | 70.9 | 61.8 | 72.2 | 68.8 | 70.7 |
| “{obj} is {att}” | 75.2 | 76 | 72.6 | 62.9 | 72.7 | 69.6 | 72 |
| “{att}{obj} is {att}” | 75.7 | 75.3 | 71.2 | 62.8 | 72.2 | 70.3 | 71.8 |

Table 3 can convey the results. One model implementation may achieve the second best overall performance, only slightly worse than TAP (Pham et al., “Improving closed and open-vocabulary attribute prediction using transformers,” in Proceedings of the European Conference on Computer Vision (ECCV), 2022.) (72.0% mAP, 62.1% mR@15 vs 73.4% mAP, 63.3% mR@15), which was trained on a much larger fully-annotated attribute dataset in addition to VAW. The model may be simpler than TAP, without considering the sophisticated object grounding. For the medium (72.0% mAP) and tail (60.6% mAP) attribute classes, the method can generate significant improvements among the baselines. The results can suggest a much stronger prior that allows the model to infer on rarely seen attributes.

The experiments can include conducting attribute prediction and object prediction studies using the VGA-A and VGA-O tasks. In both tasks, the models may have to assign higher scores to the ground truth options than the confusing items—to achieve better performance in terms of R@K (K=1,5,10)—the recall rate of the ground truth in the top-K predictions, and rank—the average rank indices (the lower the better, starting from 1) of the ground truth options in the sorted results.

The results can be shown in Table 4 and 5. The generative prompts may significantly outperform the contrastive counterparts on both datasets. The best generative prompt on VGA-A can be “{att} {obj} is {att}”, achieving a rank of 12.0, while the best one on VG Object Ranking can be “{att} {obj}”, achieving a rank of 5.8. The experiment on VG can verify the points toward the contrastive prompting in attribute learning.

Table 4 depicts results for zero-shot prediction on VGA-A.

| | Prompt Templates | Rank↓ | R@1↑ | R@5↑ | R@10↑ |
|---|---|---|---|---|---|
| Cont. | “{att}” | 17.3 | 6.3 | 22.7 | 38.4 |
| | “{att}{obj}” | 16.1 | 9.7 | 28.9 | 43.6 |
| | “{obj} is {att}” | 17.2 | 8.7 | 26.4 | 40.7 |
| | “{att}{obj} is {att}” | 16.5 | 9 | 27.9 | 42.8 |
| Gene. | “{att}” | 14 | 8.9 | 34.2 | 53 |
| | “{att}{obj}” | 13 | 13.9 | 41.6 | 58.6 |
| | “{obj} is {att}” | 13.1 | 15.2 | 42.3 | 58.6 |
| | “{att}{obj} is {att}” | 12 | 17.6 | 46.6 | 62.2 |

Table 5 depicts results for zero-shot prediction on VGA-O.

| | Prompt Templates | Rank↓ | R@1↑ | R@5↑ | R@10↑ |
|---|---|---|---|---|---|
| Cont. | “{att}” | 6 | 32.4 | 70.2 | 83.2 |
| | “{att}{obj}” | 5.9 | 34.1 | 70.2 | 82.9 |
| | “{obj} is {att}” | 5.9 | 35.3 | 70.9 | 83.2 |
| | “{att}{obj} is {att}” | 6 | 34.7 | 70 | 82.5 |
| Gene. | “{att}” | 6.1 | 31.3 | 70.3 | 83.2 |
| | “{att}{obj}” | 6 | 38.9 | 73.2 | 83.6 |
| | “{obj} is {att}” | 5.8 | 40.6 | 74.2 | 84.4 |
| | “{att}{obj} is {att}” | 6.4 | 41.6 | 72.3 | 82 |

Table 4 and 5 can show the results on VGA-A and VGA-O. In both tables, the boldface can indicate the target to be predicted, which is “{att}” for VGA-A and “{obj}” for VGA-O.

Prompt “{att}” or “{obj}” may be the least effective among the four probabilistic models, with a rank of 14.0 on VGA-A, and 6.1 on VGA-O.

Prompt “{att} {obj}” or “{obj} is {att}” may perform significantly better on both datasets than the previous approach, with rank of 13.0 on VGA-A and 6.0 on VGA-O. The generative prompt may first classify the target token, either “{att}” or “{obj}”, then checks whether the target token fits the context “[MASK] {obj}” or “[MASK] is {att}”.

Prompt “{obj} is {att}” or “{att} {obj}” can outperform the previous approach. Notably, “{att} {obj}” can achieve best performance on the VGA-O, which can suggest attributes help the classification of uncommon objects.

Prompt “{att} {obj} is {att}” or “{att} {obj} is {att}” can perform the best on VGA-A with a rank of 12.0, but the prompt can fall behind the “{att} {obj}” variant on VGA-O. The results may be attributed to the challenging nature of attribute prediction, which may benefit from the more complex relationship modeling introduced by the added conditional dependencies. On the other hand, object recognition may be dependent more on salient information, and may not necessarily benefit from these dependencies.

The VGA-A/VGA-O experiments can highlight the versatility of the proposed generative prompting. The systems and methods can be utilized to predict attributes based on objects and vice versa. The flexibility can demonstrate the foundational and expressive nature of the prefixLM approach when using generative prompting. By making simple text prompt changes, the system can construct various explainable probabilistic models, expanding the possibilities for modeling complex relationships between objects and attributes.

The systems and methods disclosed herein can use prefixLM and a generative prompting mechanism for visual attribute recognition. By leveraging the complex word dependencies captured by prefixLM during pre-training, the generative prompting can enable the explicit modeling of various object-attribute dependencies in downstream attribute tasks. The flexibility of generative prompting can be displayed by emulating various conditional dependencies, thereby unifying and simplifying the manually designed conditional dependencies. The prefixLM+generative prompting may serve as a universal framework and/or meta-model for modeling complex logical relations.

### Example Machine-Learned Models

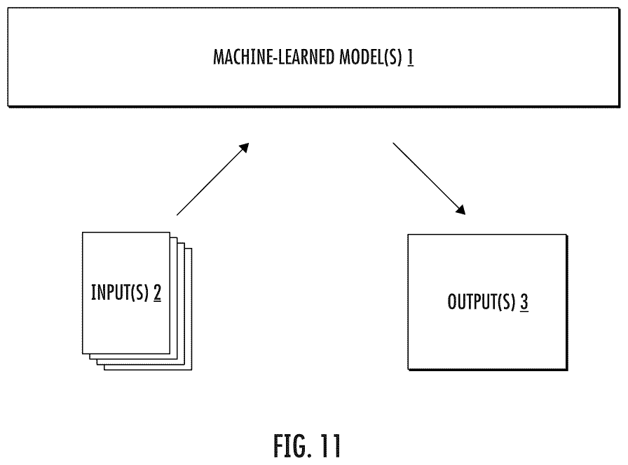

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

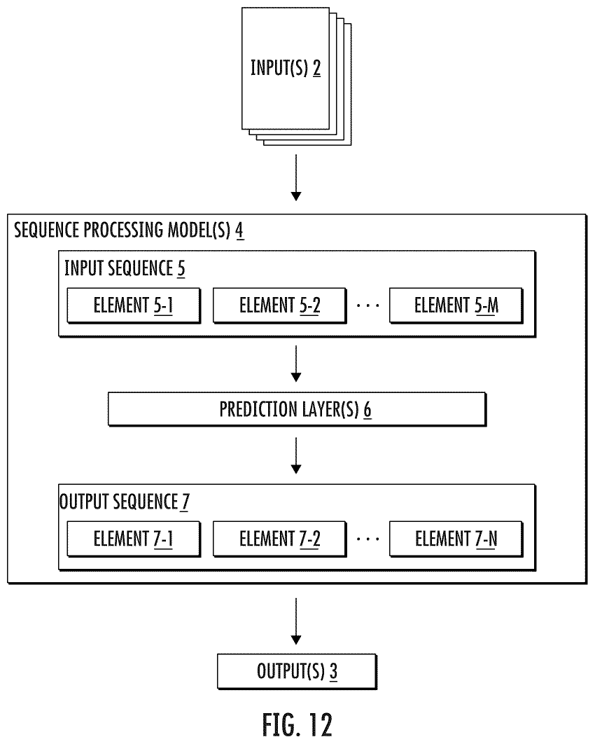

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

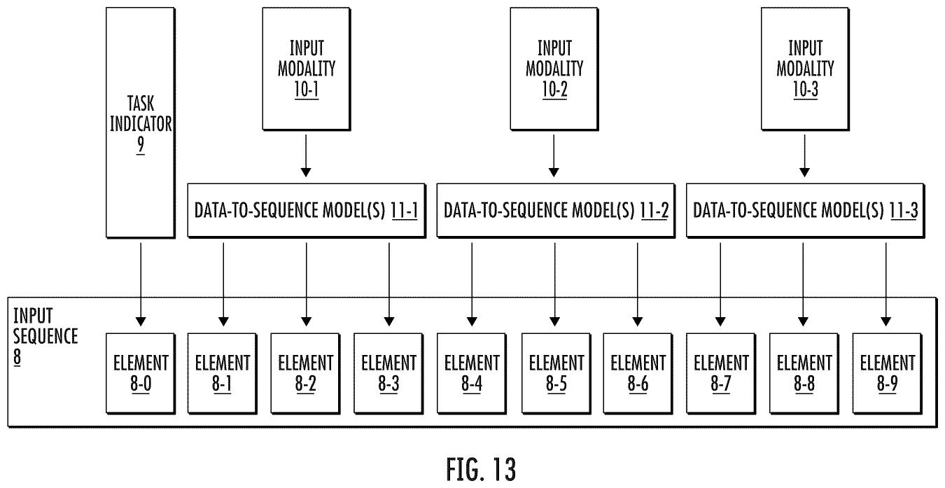

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

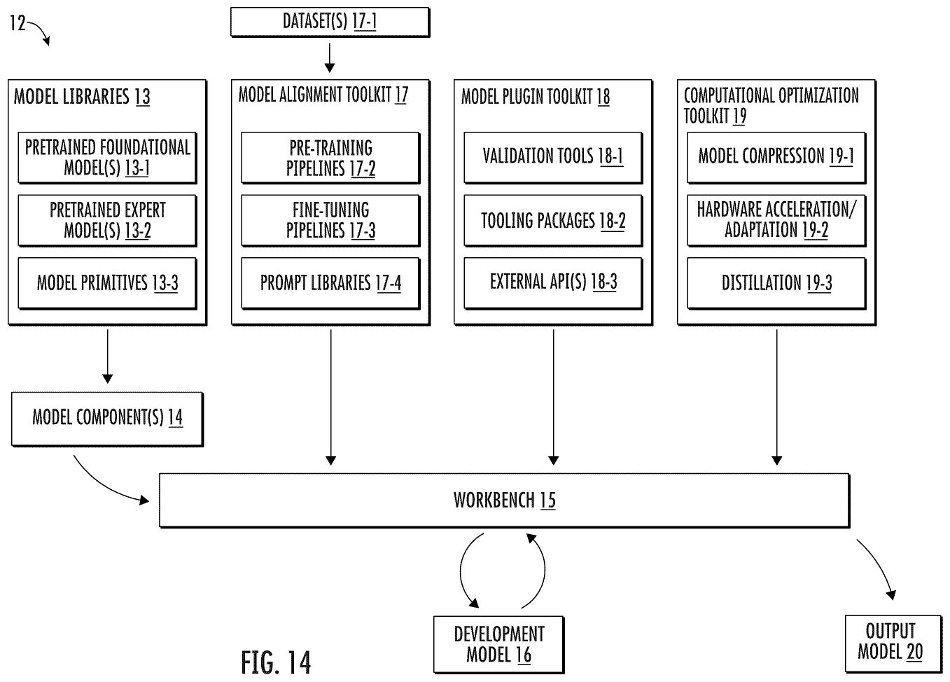

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

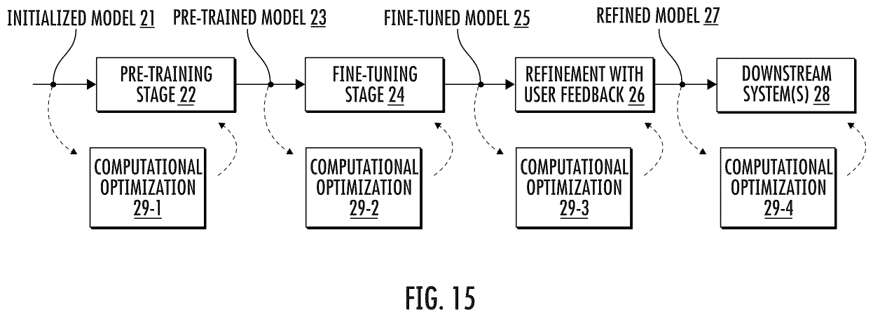

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

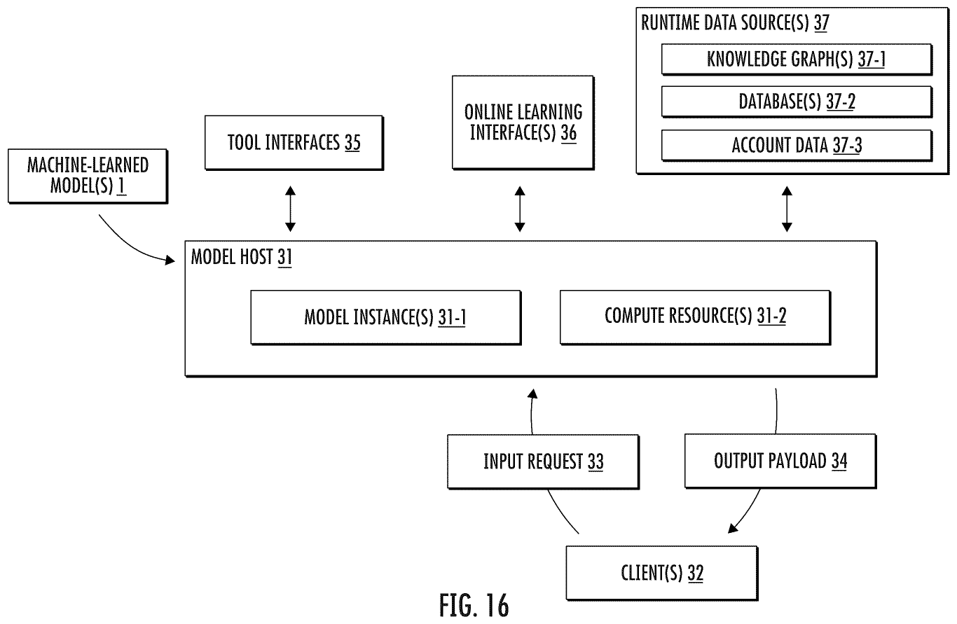

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) I can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) I can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) I can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) I can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output may include compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task may include encrypting or decrypting input data. In some cases, the task may include a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) I can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) I can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

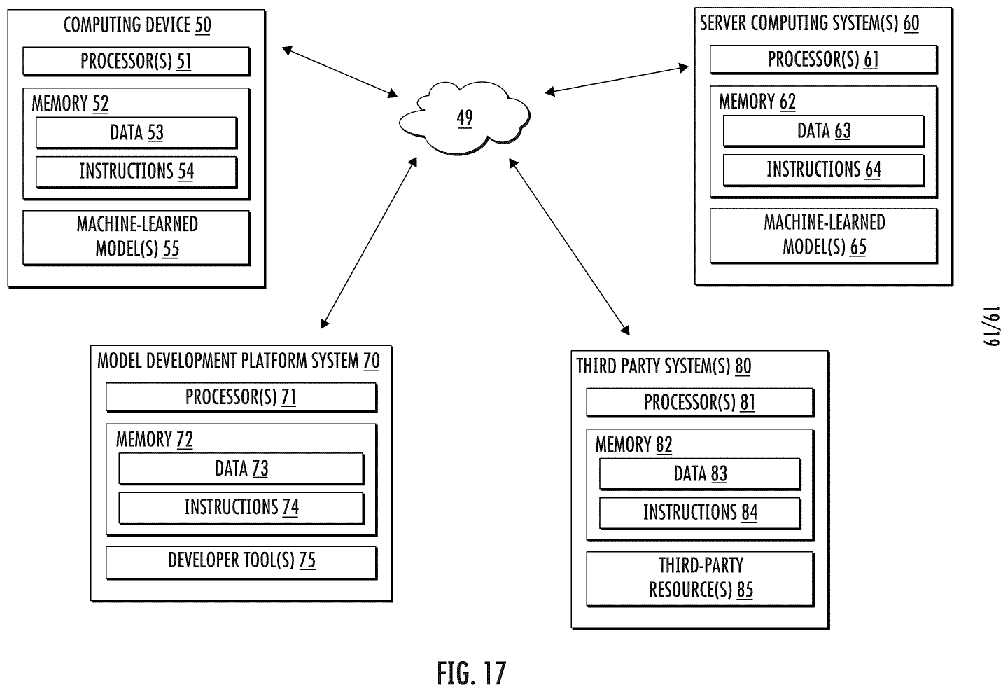

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations. X might be unable to perform Y and remain within the scope of the present disclosure.

What is claimed is:

1. A computer-implemented method for attribute captioning, the method comprising:
obtaining, by a computing system comprising one or more processors, image data and text data, wherein the image data is descriptive of one or more objects, and wherein the text data is descriptive of a particular object associated with the image data;
processing, by the computing system, the text data with a language model to determine a plurality of candidate attributes, wherein the plurality of candidate attributes comprise attributes predicted to be candidate terms that describe attributes of the particular object;
for each of the plurality of candidate attributes:
processing, by the computing system, the image data, text data, and candidate attribute with a pre-trained image-text model to determine a probability score for the candidate attribute, wherein the probability score is descriptive of a likelihood the candidate attribute is associated with the image data; and
determining, by the computing system, a particular attribute of the plurality of candidate attributes is associated with the particular object depicted in the image data based on the plurality of probability scores.

2. The method of claim 1, further comprising:
generating, by the computing system, a plurality of prompts based on the text data and the plurality of candidate attributes; and
wherein the plurality of prompts are processed with the pre-trained image-text model.

3. The method of claim 1, wherein the language model was trained to predict word sequences.

4. The method of claim 1, wherein the pre-trained image-text model was trained to generate text captions for images, wherein the text captions are descriptive of features depicted in the image.

5. The method of claim 1, wherein the plurality of candidate attributes are determined based on learned word sequences, wherein the learned word sequences were learned by training the language model.

6. The method of claim 1, wherein the pre-trained image-text model was trained on a training dataset comprising a plurality of training images and a plurality of training captions, wherein each of the plurality of training captions are descriptive of a respective caption for one or more of the plurality of training images.

7. The method of claim 1, wherein the particular attribute comprises a particular color.

8. The method of claim 1, wherein the particular attribute comprises a particular texture for the particular object.

9. The method of claim 1, wherein the particular attribute comprises an action description for the particular object, wherein the action description is descriptive of an action being performed by the particular object in the image data.

10. The method of claim 1, wherein the particular attribute comprises a specialization classification, wherein the specialization classification is descriptive of an object-specific adjective associated with the particular object.

11. A computing system for language model conditioned image captioning, the system comprising:
one or more processors; and
one or more non-transitory computer-readable media that collectively store instructions that, when executed by the one or more processors, cause the computing system to perform operations, the operations comprising:
obtaining an image, wherein the image is descriptive of one or more objects;
processing the image with a pre-trained image-text model to generate text data, wherein the text data is descriptive of a particular object depicted in the image;
processing the text data with a language model to determine a plurality of candidate attributes, wherein the plurality of candidate attributes comprise attributes predicted to be candidate terms that describe attributes of the particular object;
for each of the plurality of candidate attributes:
processing the image, text data, and candidate attribute with the pre-trained image-text model to determine a probability score for the candidate attribute, wherein the probability score is descriptive of a likelihood the candidate attribute is depicted in the image; and
determining a particular attribute of the plurality of candidate attributes is associated with the particular object depicted in the image based on the plurality of probability scores.

12. The system of claim 11, wherein the plurality of candidate attributes comprise a plurality of terms determined to be associated with the particular object based on one or more learned sequences.

13. The system of claim 11, wherein the plurality of candidate attributes comprise a plurality of adjectives and a plurality of verbs.

14. The system of claim 11, wherein the plurality of candidate attributes comprise one or more color attributes and one or more texture attributes.

15. The system of claim 11, wherein the operations further comprise:
processing the text data and the particular attribute with the language model to determine a plurality of additional candidate attributes, wherein the plurality of additional candidate attributes comprise attributes predicted to be candidate terms that describe attributes of the particular object with the particular attribute;
for each of the plurality of additional candidate attributes:
processing the image, text data, particular attribute, and candidate attribute with the pre-trained image-text model to determine an additional probability score for the additional candidate attribute, wherein the additional probability score is descriptive of a likelihood the additional candidate attribute is depicted in the image; and
determining a particular additional attribute of the plurality of additional candidate attributes is associated with the particular object with the particular attribute depicted in the image based on the plurality of additional probability scores.

16. The system of claim 11, wherein the operations further comprise:
before obtaining the image:
obtaining a training dataset, wherein the training dataset comprises a plurality of training examples, wherein each training example comprises an image example and a respective caption example, wherein the respective caption example is descriptive of a caption for the image example; and
training an image-text model based on the training dataset to generate captions for input images.

17. One or more non-transitory computer-readable media that collectively store instructions that, when executed by one or more computing devices, cause the one or more computing devices to perform operations, the operations comprising:
obtaining a training dataset, wherein the training dataset comprises a plurality of training examples, wherein each training example comprises an image example and a respective caption example, wherein the respective caption example is descriptive of a caption for the image example;
training an image-text model based on the training dataset to generate captions for input images;
obtaining image data and text data, wherein the image data is descriptive of one or more objects, and wherein the text data is descriptive of a particular object associated with the image data;
processing the text data with a language model to determine a plurality of candidate attributes, wherein the plurality of candidate attributes comprise attributes predicted to be candidate terms that describe attributes of the particular object;
for each of the plurality of candidate attributes:
processing the image data, text data, and candidate attribute with the image-text model to determine a probability score for the candidate attribute, wherein the probability score is descriptive of a likelihood the candidate attribute is associated with the image data; and
determining a particular attribute of the plurality of candidate attributes is associated with the particular object depicted in the image data based on the plurality of probability scores.

18. The one or more non-transitory computer-readable media of claim 17, wherein the text data is descriptive of the particular object and a particular adjective for the particular object.

19. The one or more non-transitory computer-readable media of claim 18, wherein the plurality of candidate attributes are determined based on a text string comprising the particular object and the particular adjective.

20. The one or more non-transitory computer-readable media of claim 17, wherein the image-text model comprises:
one or more image encoders;
one or more unimodal text decoders; and
one or more multimodal text decoders.
